(19) United States
(12) Patent Application Publication
(10) Pub. No.: US 2001/0047320 A1
(43) Pub. Date: Nov. 29, 2001

(54) Financial instrument transactions based on patent practitioner employment

(76) Inventor: Martin G. Meder, Blacksburg, VA (US)

Correspondence Address: MARTIN G. MEDER, 1415 LOCUST AVENUE, BLACKSBURG, VA, 24060, US

(21) Appl. No.: 09/861,810

(22) Filed: May 21, 2001

Related U.S. Application Data
(60) Provisional application No. 60/207,373, filed on May 26, 2000.

(51) Int. Cl. G06F 17/60

(52) U.S. Cl. 705/36; 705/37; 705/1

(57) ABSTRACT

The invention includes a method of transacting financial instruments, comprising tracking patent practitioner employment in a company over time to observe changes in the number of patent practitioners employed by the company; and performing a transaction on a financial instruments of the company based, at least in part, on the patent practitioner employment in the company. An institutional or mutual fund based on the above method is also described.

This application claims priority of U.S. provisional patent application Serial No. 60/207,373, filed May 26, 2000.

### FIELD OF THE INVENTION

This invention relates to buying and selling securities and financial instruments.

### BACKGROUND

Decisions of whether to buy or sell the financial instruments such as securities of a given company often are based on the strength, or lack thereof, of the patent portfolio of that company compared to other companies in the same industry. Patent portfolio strength is measured not just on the number of patents issued, but also on things like technological strength, such as the number of times the patents in the portfolio are cited in other patents. The disadvantage of this technique in a fast-moving investment climate is that the earliest a trend in a shift in a company's emphasis towards patents can be detected is by looking at 18 month publication numbers, and the earliest that such a trend can be confirmed is in about 2 years after the portfolio has been significantly strengthened or weakened.

### SUMMARY OF THE INVENTION

The invention includes a method of transacting financial instruments, comprising tracking patent practitioner employment in a company over time to observe changes in the number of patent practitioners employed by the company; and performing a transaction on a financial instruments of the company based, at least in part, on the patent practitioner employment in the company. An institutional or mutual fund based on the above method is also described.

### DETAILED DESCRIPTION OF THE INVENTION

If the number of patent practitioners at a company increases suddenly from 1 to 10, for example, it can reasonable be expected that that company intends to increase its patent portfolio for offensive or defensive reasons, or to increase licensing activities, or engage in litigation or any combination of the above. Therefore, it would be valuable for investors to be aware of this information in a time period well in advance of that available from looking at patent portfolio statistics. Patent practitioners, such as agents and attorneys, are required by law to register their contact information and provide any changes to that information in a timely fashion. In the United States, for example, patent practitioners register with the United States Patent and Trademark Office (USPTO). Generally practitioners provide their place of employment rather than a home address, because that is where practitioners will want to be contacted by the patent office. In the past, changes in this information has been difficult to ascertain in a timely fashion because the roster of attorneys and agents was only published annually. However, the contact information is now provided on the World Wide Web on almost a real time basis. Currently it is updated about weekly in the United States and can be found at: www.uspto.gov/web/offices/dcom/olia/oed/roster/index.html (preface with “http://”) to execute). Similar information is also available from other national patent offices as well as for European patent attorneys from the European Patent Office at: www.european-patent-office.org/reps/search.html (preface with “http://”) to execute).

Contact information is provided for all practitioners, including those working for law firms, the government and corporations. The contact information can be downloaded as often as desired and it will be seen that a given company in any week has a certain number of practitioners registered. A practitioner employment change for any company can be monitored over time by comparing subsequent roster downloads to prior ones. Employment data at law firms may be discarded or ignored. In a preferred embodiment, technical display charts showing patent practitioner employment numbers over time at a company can be created comparing the company to others within its industry, such as biotech firms compared to each other or financial companies compared to each other. In this manner, even if there is no change in employment, the practitioner employment information gains importance by virtue of other companies in the same industry having large relative increases or decreases in practitioner employment. A database of company practitioner employment history can be built up over time and saved on a computer readable storage medium, the database queried or instructed to flag and report changes. In another preferred embodiment, it is also possible to construct technical charts for display comparing practitioner employment in a company over time with financial data of the same company including stock price, earnings, price/earnings ratio, research and development spending, market capitalization, yield, total number of employees, earnings per share, earnings per share growth, years to liquidate debt, enterprise value divided by operating income, trading volume, stock price percentage gain or loss, indexes for the industry that the company is in and the like. These charts are made available for buy and sell decision making by stock market analysts.

With the patent practitioner employment data for a company in hand, decisions can be made with respect to whether to conduct financial instrument transactions such as buy, sell, lock-in a future buy or sell order, use securities as collateral and the like. Financial instruments include common and preferred stock, American Depository Receipts (ADRs), stock options, convertible bonds, futures commodity contracts (like steel if the company is a steel company), bonds, warrants and the like.

While one preferred embodiment of the invention is a method of transacting financial instruments, comprising tracking patent practitioner employment in a company over time to observe changes in the number of patent practitioners employed by the company; and performing a transaction on a financial instrument of the company based, at least in part, on the patent practitioner employment in the company, another preferred embodiment is a mutual fund based on the same principle. In such a mutual fund, decisions to buy or sell stock would be based, at least in part, on patent practitioner employment. In an exemplary embodiment, an institutional or mutual securities fund, comprises securities of companies selected at least in part by tracking patent practitioner employment in companies over time to observe changes in the number of patent practitioners employed by each of the companies; and performing a transaction on a security of at least one of the companies based, at least in part, on the patent practitioner employment in at least one of the companies. This is particularly important for high-tech industries, but also for commodities industries, where patent protection is the only marketing advantage that may be available.

While it is particularly preferred that patent practitioner employment information is used to trade in the securities of publicly owned corporations, it may also be used to decide whether to invest in shares of pre-initial public offering companies and whether to purchase a private company in toto (essentially all shares). Note that as used herein “company” refers to all forms of ownership used domestically and internationally including corporation, incorporated, Ltd. (limited liability), S.A. (society of the anonymous, used in civil law countries), KGAa, GmbH, and the like.

Although various embodiments of the invention are shown and described herein, they are not meant to be limiting, for example, those of skill in the art may recognize certain modifications to these embodiments, which modifications are meant to be covered by the spirit and scope of the appended claims

I claim:

1. A method of transacting financial instruments, comprising:
tracking patent practitioner employment in a company over time to observe changes in the number of patent practitioners employed by the company; and
performing a transaction on a financial instrument of the company based, at least in part, on the patent practitioner employment in the company.

2. The method of claim 1, wherein the patent practitioner employment data of the company is compared to patent practitioner employment data of other companies in the same industry.

3. The method of claim 1, wherein the patent practitioner employment data of the company is compared to financial data.

4. The method of claim 1, wherein the patent practitioner employment data of the company is compared to at least one of the company's stock price, earnings, price/earnings ratio, market capitalization, yield, total number of employees, research and development spending, earnings per share, earnings per share growth, years to liquidate debt, enterprise value divided by operating income, trading volume, stock price percentage gain or loss and indexes for the industry that the company is in.

5. The method of claim 1, wherein the financial instrument is at least one of common stock, preferred stock, American depository receipts, convertible bonds, bonds, warrants, stock options and futures commodity contracts.

6. The method of claim 1, wherein the financial instrument transaction is at least one of buying, selling, a future buy order, a future sell order, and collateralizing an underlying security.

7. The method of claim 1, wherein the company is a publicly traded company.

8. The method of claim 1, wherein the financial instrument is a security.

9. A financial instrument fund, comprising financial instruments of companies selected at least in part by:
tracking patent practitioner employment in companies over time to observe changes in the number of patent practitioners employed by each of the companies; and
performing a transaction on a financial instrument of at least one of the companies based, at least in part, on the patent practitioner employment in at least one of the companies.

10. The fund of claim 9, wherein the patent practitioner employment data of the company is compared to patent practitioner employment data of other companies in the same industry.

11. The fund of claim 9, wherein the patent practitioner employment data of the company is compared to financial data.

12. The fund of claim 9, wherein the patent practitioner employment data of the company is compared to at least one of the company's stock price, earnings, price/earnings ratio, market capitalization, yield, total number of employees, research and development spending, earnings per share, earnings per share growth, years to liquidate debt, enterprise value divided by operating income, trading volume, stock price percentage gain or loss and indexes for the industry that the company is in.

13. The fund of claim 9, wherein the financial instrument is at least one of common stock, preferred stock, American depository receipts, convertible bonds, bonds, warrants, stock options and futures commodity contracts.

14. The fund of claim 9, wherein the financial instrument transaction is at least one of buying, selling, a future buy order, a future sell order, and collateralizing an underlying security.

15. The fund of claim 9, wherein the financial instrument fund is a mutual fund.

16. The fund of claim 9, wherein the financial instrument fund is an institutional fund.

17. The fund of claim 9, wherein the financial instrument is a security.

18. A computer readable storage medium comprising change in company patent practitioner employment over time.
